(19) United States
(12) Patent Application Publication
(10) Pub. No.: US 2026/0161136 A1
(43) Pub. Date: Jun. 11, 2026

(54) SHOCK ABSORBING SUPPORT

(71) Applicant: Montres Breguet S.A., L'Abbaye (CH)

(72) Inventor: Jean-Philippe ROCHAT, Les Bioux (CH)

(73) Assignee: Montres Breguet S.A., L'Abbaye (CH)

(21) Appl. No.: 19/350,261

(22) Filed: Oct. 6, 2025

(30) Foreign Application Priority Data
Dec. 6, 2024 (EP) 24218084.2

(51) Int. Cl. G04B 43/00

(52) U.S. Cl. CPC G04B 43/002

(57) ABSTRACT

A support for a horology movement, in particular a bar or a plate. The support includes a base and an interface designed to hold a horology component. A remarkable feature of the support is that it also comprises a shock absorber arranged between the base and the interface and arranged so as to absorb vibrations between the horology component and the base of the support. Also, a movement including such a support and a timepiece including such a movement.

### CROSS-REFERENCE TO RELATED APPLICATIONS

This application claims priority to European Patent Application No. 24218084.2 filed on December 6, 2024, the entire contents of which are incorporated herein by reference.

### TECHNICAL FIELD OF THE INVENTION

The present invention relates to the field of horology. More specifically, it relates to a support such as a plate or bar for a horology movement. The invention also relates to a movement comprising such a support and to a timepiece fitted with such a movement.

### TECHNOLOGICAL BACKGROUND

Numerous solutions have been used to meet the need to limit the propagation of vibrations in a horology movement. Most aim to limit the consequences of a shock to the watch, for example as a result of dropping it. Other devices aim to make the movement quieter by limiting the propagation of vibratory waves.

In the latter category, application EP3418595 describes a ball bearing for a timepiece designed to support an oscillating mass for automatic winding. It appears that the rotation of the balls on the rolling tracks of a conventional bearing generates vibrations that are propagated to the entire movement via the fastening of the bearing and the bar on the oscillating mass. Vibrations are easily transmitted between hard materials that are in contact, for example, between the movement and the watch case, and can therefore be perceived by the wearer of the watch. To reduce the noise and vibrations caused by the oscillating mass bearing, it is proposed to add a shock-absorber ring between the inner cage of the bearing and its fastening ring, so that no vibration from the bearing can propagate to the rest of the movement without first being filtered by the material of which the shock absorber is made.

However, the use of such a bearing can have certain drawbacks. The addition, on the bearing, of a shock-absorber ring made of a shock-absorbing material that is less rigid than a hard material does not result in the same performance in terms of rigidity as with a conventional bearing of equivalent dimensions made of a metallic or ceramic material. However, it is important to ensure that the oscillating mass is held securely in the plane so that it does not come into contact with the glass, middle, plate or bars. As a result, the dimensions and especially the thickness of these bearings will have to be increased to achieve a rigidity equivalent to that of a bearing without a shock absorber.

Moreover, most watches have a back glass that allows the underside of the movement to be seen, in particular the oscillating mass and its bearing. At least partial visibility of the shock absorber, which is made from a non-noble material, typically an elastomer, can alter the perceived quality of the movement and discourage the use of these bearings in high-end parts.

There is thus an interest in developing alternative solutions to remedy the limitations of the prior art.

### SUMMARY OF THE INVENTION

The purpose of the invention is achieved by a support such as a bar or plate in a horology movement, said support comprising a base and an interface for holding a horology component. In a novel approach, the support also comprises a shock absorber arranged between the base and the interface.

This configuration makes it possible for vibrations between the horology component and the base of the support, and consequently between the horology component and the rest of the movement, to be absorbed.

According to an advantageous embodiment of the invention, the shock absorber (4) is at least partially turned in the thickness of the support (1).

According to an advantageous embodiment of the invention, said shock absorber is made of an elastomer, in particular an EPDM rubber, a thermoplastic, a shape memory material, an epoxy resin or a polyurethane resin.

According to an advantageous embodiment of the invention, the shock absorber is obtained by overmoulding onto the base.

According to an advantageous embodiment of the invention, the shock absorber is obtained by overmoulding onto the interface.

According to an advantageous embodiment of the invention, the shock absorber is clipped onto the base and the interface.

According to an advantageous embodiment of the invention, the base comprises an outer groove and the interface comprises an inner groove.

According to an advantageous embodiment of the invention, the support is a bar on which the interface is designed to hold an oscillating mass and its bearing.

According to an advantageous embodiment of the invention, the support is a bar on which the interface is designed to hold a plate.

According to an advantageous embodiment of the invention, the support is a plate on which the interface is designed to hold a bar.

According to an advantageous embodiment of the invention, the shock absorber has a hardness comprised between 40 and 95 Shore A.

The invention also relates to a horology movement comprising in a support as described above.

According to an advantageous embodiment of the invention, the support on the horology movement is an oscillating mass bar, the base of which is fastened to a plate and the interface of which is secured to a fastening means (5, 6) designed to keep an inner ring of a bearing carrying an oscillating mass pressed against the shock absorber on the support.

Lastly, the invention relates to a timepiece comprising a horology movement as described above.

### BRIEF DESCRIPTION OF THE FIGURES

The purposes, advantages and characteristics of the present invention will become apparent on reading the embodiments provided solely by way of non-limiting example, with reference to the appended drawings in which:

FIG. 1 shows a perspective cross-sectional view of an oscillating mass bar according to the prior art,

FIG. 2 shows a similar cross-section of an oscillating mass bar according to the invention,

FIG. 3 is a cross-sectional view of the bar in FIG. 2 without the shock absorber,

FIG. 4 shows the same cross-section as FIG. 3 with the shock absorber,

FIG. 5 shows a partial cross-section of a movement comprising a bar according to the invention,

FIG. 6 shows a partial cross-section of the fastening of a bar to a plate, with a shock absorber according to the invention located on the bar,

FIG. 7 shows a partial cross-section of the fastening of a bar to a plate, with a shock absorber according to the invention located on the plate.

### DETAILED DESCRIPTION OF THE INVENTION

FIGS. 2 to 5 show a first embodiment of the invention, but the invention is not limited to this particular embodiment.

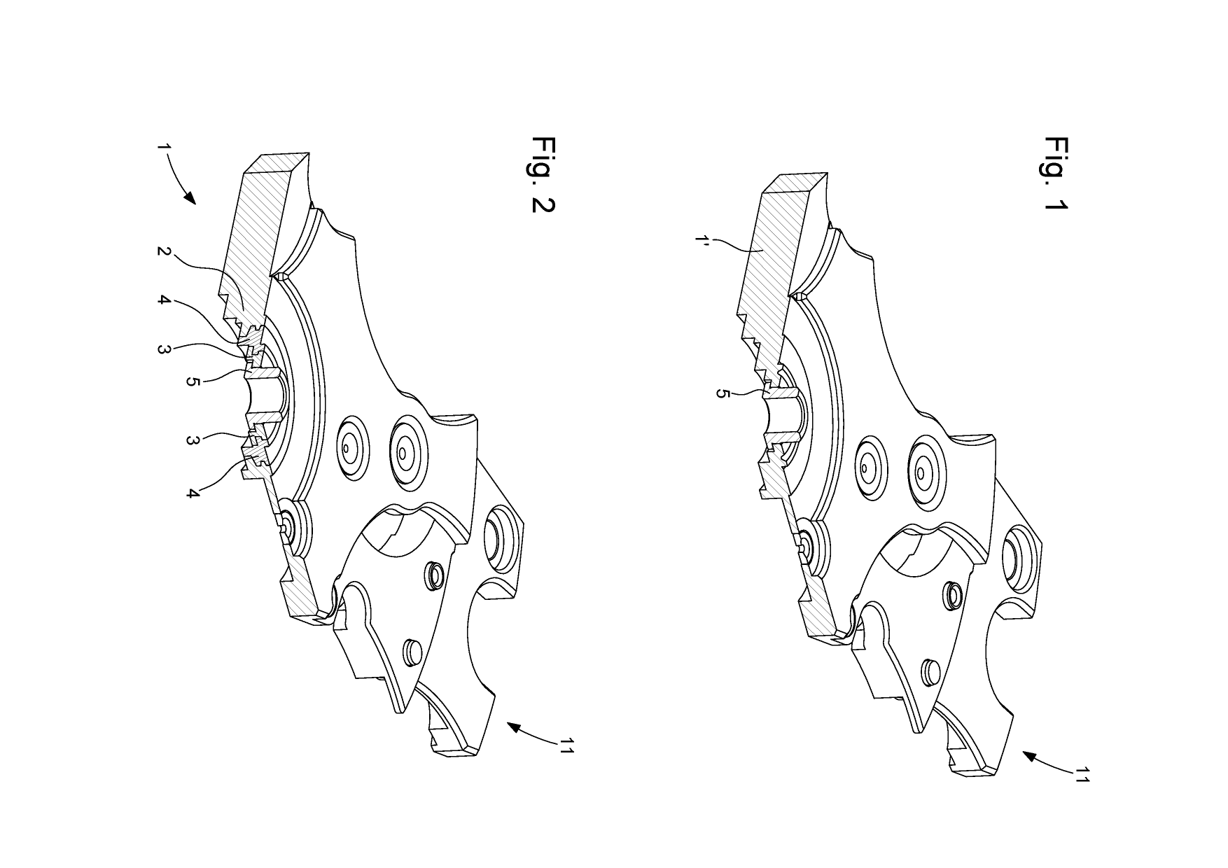

The invention relates to a support, which is the generic name given in the present application to designate a bar or plate in a horology movement. A conventional support 1' according to the prior art is illustrated in FIG. 1 in the form of an oscillating mass bar. The entire bar is made from a hard material, either metallic or ceramic. The conventional support 1' comprises an opening in which a threaded insert 5 is driven in for holding a bearing carrying an oscillating mass. The inner ring of the bearing is pressed against the conventional support 1' by a nut engaging with the threaded insert 5. In this configuration, the contact of the inner ring on the bearing pressing directly against the bar on the oscillating mass promotes the transmission of vibrations from the bearing to the rest of the movement.

FIGS. 2 to 5 show a first embodiment of a support 1 according to the invention in the form of an oscillating mass bar, similar to the one shown in FIG. 1. However, it differs from the conventional support 1' of the prior art in that it consists of several elements, namely a base 2, an interface 3 and a shock absorber 4 located between the base 2 and the interface 3.

The interface 3 is designed to hold a horology component, which means that the interface can accommodate said component or accommodate a fastening means designed to connect the support 1 to the horology component. In the first exemplary embodiment, the horology component is an oscillating mass with its bearing and the interface 3 holds a means for fastening the bearing. The fastening means shown is a threaded insert 5 designed to engage with a nut 6. Other fastening means would be suitable, such as a screw foot and a screw or a screw and a nut.

The term ‘horology component’ is to be broadly construed and refers to all horology elements that can be fitted on the support or fastened to it. Examples include components that can be fitted to a plate or a bar, such as stones, but also other supports such as plates or bars, as shown in the other embodiments.

The shock absorber 4 is arranged between the base 2 and the interface 3 and is used to absorb vibrations between the horology component and the base 2 of the support 1. The direction in which the vibrations propagate is irrelevant, as the shock absorber support according to the invention is used both to isolate a component that is a source of vibrations, such as an oscillating mass, and to protect a component from vibrations or shocks originating from outside the watch.

To optimise vibration absorption, the shock absorber 4 is made from an absorbent material, for example, an elastomer polymer such as EPDM rubber, a thermoplastic, an epoxy resin or a polyurethane resin, or a shape memory alloy (SMA).

Preferably, the material used to make the shock absorber has a hardness comprised between 40 and 95 Shore A.

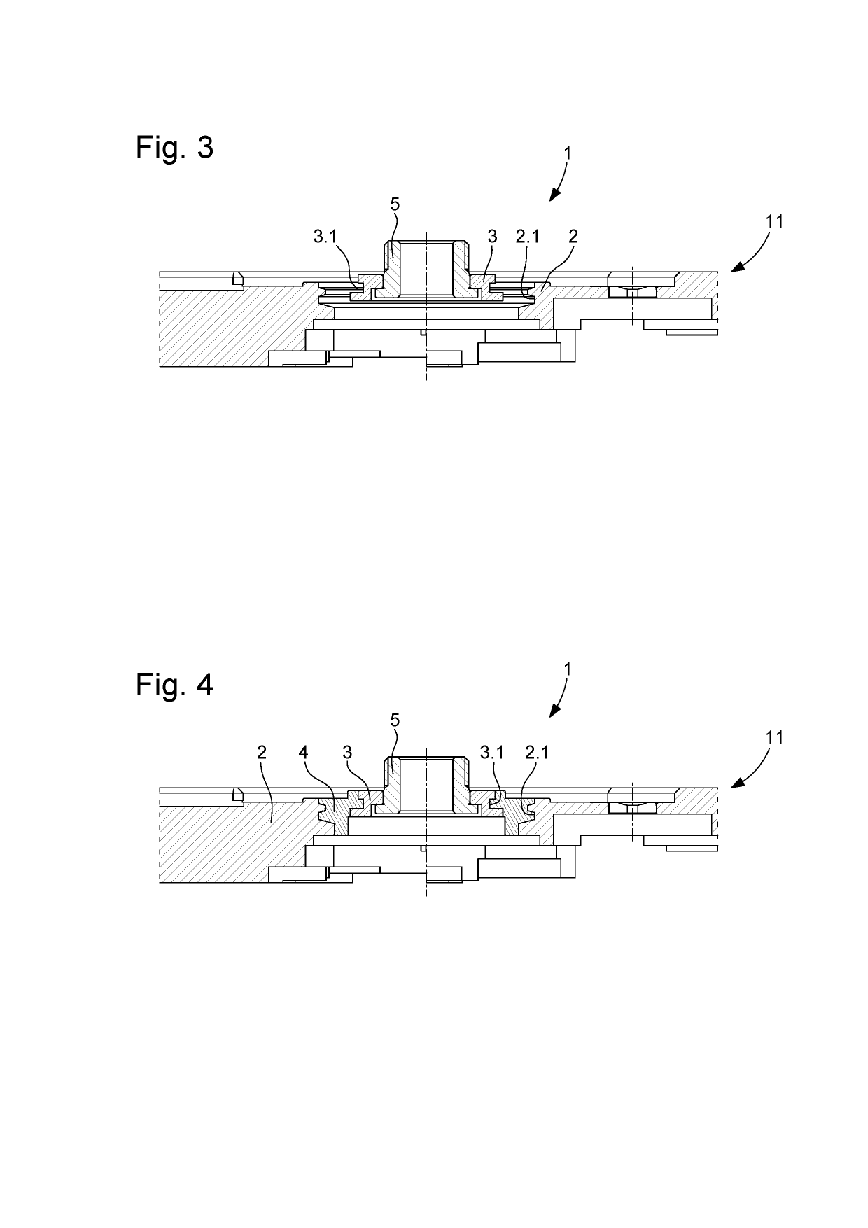

The shock absorber 3 can be produced by injection moulding or by casting in a mould. Preferably, the shock absorber 3 can be overmoulded onto the base 2 and the interface 3. To do this, the base 2 and the interface 3 are placed in a mould in the position shown in FIG. 3. The absorbent material is then injected into the cavity formed by the base 2, the interface 3 and the mould.

To ensure good cohesion between the shock absorber, the base 2 and the interface 3, the surfaces of the base 2 and the interface 3 in contact with the shock absorber 4 preferably have marked reliefs such as ribs, grooves or cavities. In the example shown, the base 2 comprises an outer groove 2.1 and the interface 3 comprises an inner groove 3.1.

As an alternative to overmoulding, the shock absorber 4 can be clipped onto the base 2 and the interface 3, or in other words, press-fitted, making use of the resilient nature of the material of which the shock absorber 4 is made.

Of course, the overmoulding and clipping methods can be combined. The shock absorber 4 can, for example, be overmoulded onto the base 2 before being clipped onto the interface 3. Conversely, the shock absorber 4 can be overmoulded onto the interface 3 before being clipped onto the base 2.

Once the various components of the support 1 have been assembled, the result is a single-piece assembly that is as easy to handle as a conventional support 1'.

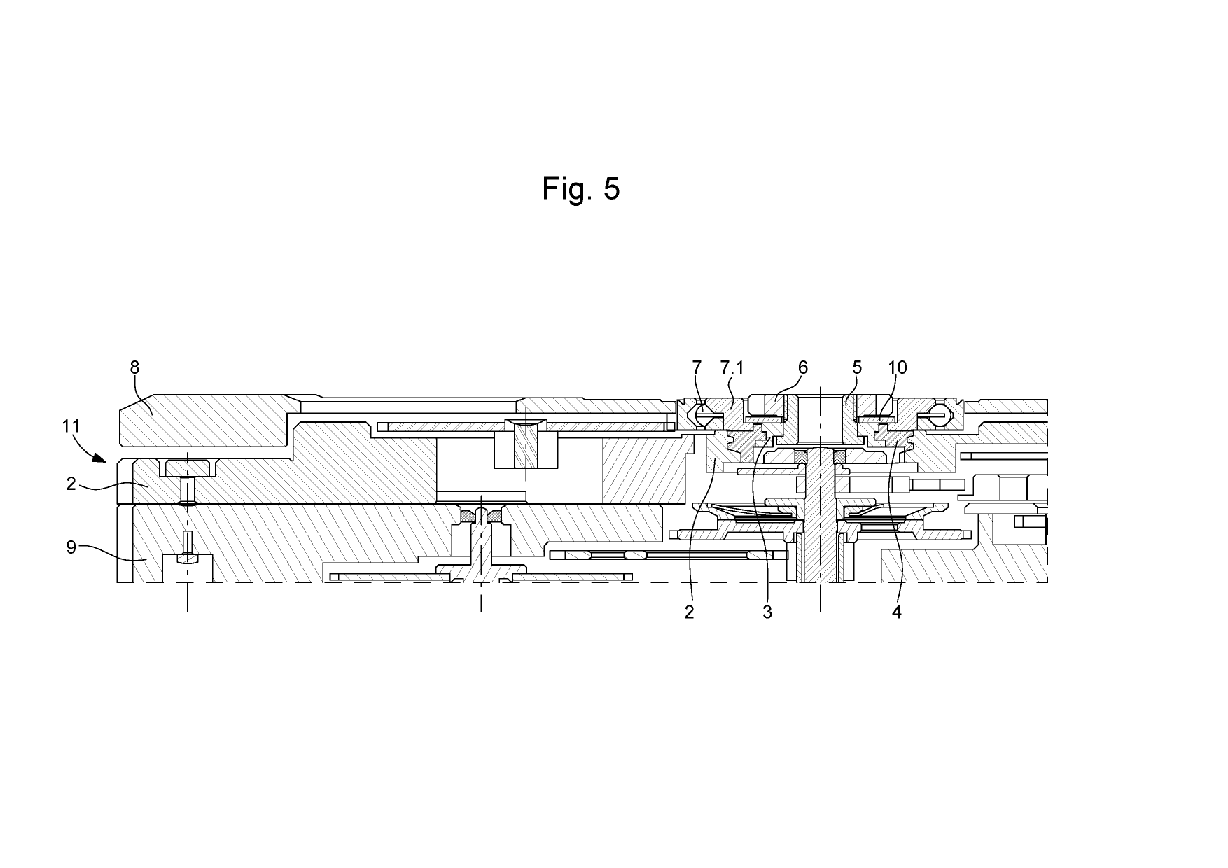

FIG. 5 shows a partial cross-sectional view of a horology movement comprising a support 1 according to the invention. The support in question is an oscillating mass bar, the base 2 of which is secured to a plate 9. The interface 3 is fastened to a threaded insert 5 that engages with a nut 6. The inner ring 7.1 of a bearing 7 carrying an oscillating mass 8 is kept pressed against the shock absorber 4 on the support 1 by the nut 6. Preferably, a washer 10 is fitted between the nut 6 and the inner ring 7.1 of the bearing 7. This design makes it possible to isolate the bearing from the base 2, thereby attenuating the vibrations from the oscillating mass and the bearing in the rest of the movement.

A person skilled in the art will be able to change this exemplary design without departing from the scope of the invention.

In an advantageous variant, the interface 3 is the direct fastening means for the horology component. In the case of a bearing, the interface 3 can be a threaded rod or a tapped screw foot. In the case of a stone, the interface can be the setting designed to hold the stone. This design reduces the number of components and makes it easier to assemble the movement.

Of course, several shock absorbers can be fitted to a single support 1. These various shock absorbers can be produced in a single overmoulding operation, which means lower manufacturing costs compared with a solution in which each component would have a specific shock absorber insert.

In the case of an oscillating mass bar, the proposed solution allows for greater freedom of design as it is compatible with conventional bearings. Incorporating the shock absorber into the thickness of the bar enables vibrations from the oscillating mass bearing to be filtered out without requiring specific, thicker bearings and without the shock absorber being visible to the user.

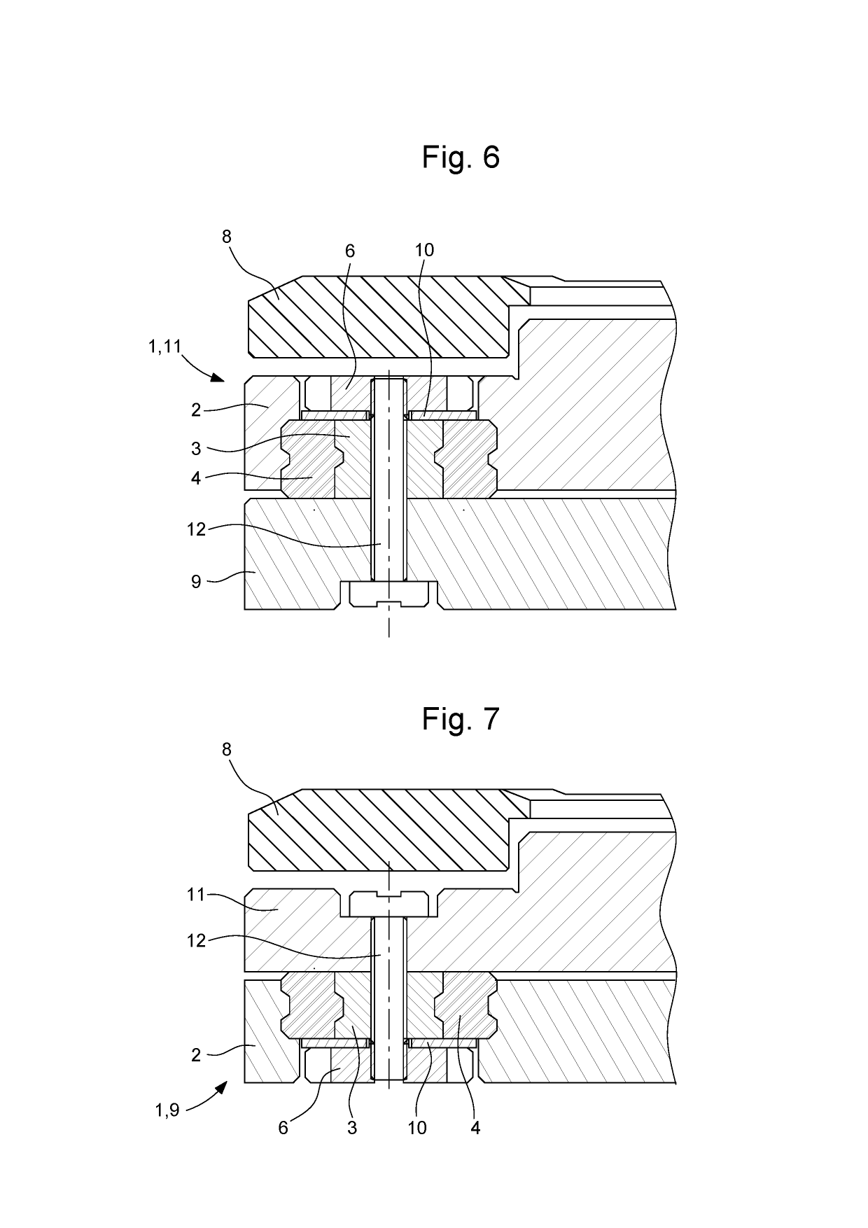

FIG. 6 shows another embodiment of the invention in which the support 1 is in the form of a bar 11 consisting of a base 2, an interface 3 and a shock absorber 4. The interface 3 is designed to hold a screw 12 that engages with a nut 6 to fasten the bar 11 to the plate 9. Tightening the nut 6 on the screw 12 enables the interface 3 to be pressed against the plate 9 via the washer 10. Preferably the shock absorber 4 is slightly compressed when the nut is tightened. The interface 3 makes it possible to achieve a predetermined compression of the shock absorber 4 while keeping the shock absorber from being crushed during tightening. This design also enables the bar to be precisely positioned with reference to the plate in a vertical direction. Since the base 2 of the bar is only in contact with the shock absorber 4, the transmission of vibrations between the base 2 of the bar 11 and the plate 9 is greatly reduced. The bar 11 preferably comprises a shock absorber on each element fastening it to the plate 9.

FIG. 7 shows a fastener for a bar 11 and a plate 9 similar to the previous one. However, it differs in that the support 1 is in this case a plate 9 consisting of a base 2, an interface 3 and a shock absorber 4, and in that the horology component is a bar 11. All vibrations propagating between the bar 11 and the base 2 of the plate 9 travel through the shock absorber 4 and are therefore dampened.

Another advantage of the invention is the positioning of the shock absorber, which is at least partially turned in the thickness of the support. Compared to a solution in which a shock absorber would simply be superimposed by being sandwiched between the support and the horology component, this particular arrangement makes it possible to achieve significant distortion of the shock absorber and thereby high absorption capacities, particularly in the vertical direction, without increasing the thickness of the assembly.

### Terminology

1. Support

1'. Conventional support

2. Base

2.1 Outer groove

3. Interface

3.1 Inner groove

4. Shock absorber

5. Threaded insert

6. Nut

7. Bearing

7.1 Inner ring

8. Oscillating mass

9. Plate

10. Washer

11. Bar

12. Screw

1. A support (1) for a horology movement, in particular a bar or a plate, said support (1) comprising a base (2) and an interface (3) for holding a horology component, wherein the support (1) comprises a shock absorber (4) arranged between the base (2) and the interface (3) and designed to absorb vibrations between the horology component and the base (2) of the support (1).

2. The support according to claim 1, wherein the shock absorber (4) is at least partially turned in the thickness of the support (1).

3. The support according to claim 2, wherein the shock absorber (4) is made of an absorbent material, in particular an elastomer, an EPDM rubber, a thermoplastic, an epoxy resin, a polyurethane resin or a shape memory alloy.

4. The support according to claim 1, wherein the shock absorber (4) is obtained by overmoulding onto the base (2).

5. The support according to claim 1, wherein the shock absorber (4) is obtained by overmoulding onto the interface (3).

6. The support according to claim 1, wherein the shock absorber (4) is clipped onto the base (2) and the interface (3).

7. The support according to claim 1, wherein the base (2) comprises an outer groove (2.1) and in that the interface (3) comprises an inner groove (3.1).

8. The support according to claim 1, wherein the support (1) is a bar on which the interface (3) is designed to hold an oscillating mass and its bearing.

9. The support according to claim 1, wherein the support (1) is a bar (11) on which the interface (3) is designed to hold a plate (9) or in that the support (1) is a plate (9) on which the interface (3) is designed to hold a bar (11).

10. The support according to claim 1, wherein the shock absorber has a hardness comprised between 45 and 95 Shore A.

11. A horology movement comprising a support (1) according to claim 1.

12. The horology movement according to claim 11, wherein the support (1) is an oscillating mass bar, the base (2) of which is fastened to a plate (9) and the interface (3) of which is secured to fastening means (5, 6) designed to keep an inner ring (7.1) of a bearing (7) carrying an oscillating mass (8) pressed against the shock absorber (4) on the support (1).

13. A timepiece comprising a horology movement according to claim 11.
